(19) United States
(12) Patent Application Publication
(10) Pub. No.: US 2006/0145658 A1
(43) Pub. Date: Jul. 6, 2006

(54) Method and device for battery charger and diagnosis with detectable battery energy barrier

(75) Inventor: Jeen-Shuh Wang, Taipei City (TW)

Correspondence Address: TROXELL LAW OFFICE PLLC, SUITE 1404, 5205 LEESBURG PIKE, FALLS CHURCH, VA, 22041, US

(73) Assignee: JASON AUTO TECHNOLOGY CO., LTD.

(21) Appl. No.: 11/318,884

(22) Filed: Dec. 28, 2005

(30) Foreign Application Priority Data
Dec. 31, 2004 (CN) 093141931

(51) Int. Cl. H02J 7/00

(52) U.S. Cl. 320/107

(57) ABSTRACT

Methods and device for battery charging and diagnosis provide a measuring batter energy state in which charging strategy alternate with the minimize balance between battery energy state and charging energy in which the balance is existed in battery energy barrier. Variance battery energy barrier derives adaptive charging cycle and charging protection in to approach the requirements of safety, full charge and high performance for lead-acid battery. The charging cycle derives protection mode to adapt the initial battery energy barrier state, and derives diagnosis mode to adapt electrolyte activities diffusion state, and derives the charging mode in optimum strategy to adapt polarization, storage and saturation cycle by using measure battery energy barrier, and derives the alert indication mode to result the charging cycles and diagnosis, in which the output charging energy is derived as continuous and minimum energy in inhibit of reduce efficiency due to the violent agitation and the fluctuation phenomenon in appearance in charging cycle. This invention comprise Primary power supply unit, measurement and control unit, secondary side control unit and alert/indication unit to feature the functions with stable, safety, full charging, high efficiency, diagnostic and longevity charger.

### BACKGROUND OF THE INVENTION

The present invention relates to a method and device for battery charger and diagnosis with detectable battery energy barrier, which is a method concerning the measurement of battery charge status, and the derivation of the charge method suitable for the battery status, and the diagnosis of whether the battery is normal. In the actual circuit implementation of this invention, the safety, efficiency and full-charge of lead-acid batteries can be achieved.

For the techniques of charging rechargeable batteries, the characteristics of full-charge and safety are required. For the charge of lead-acid batteries, it is even further required not to decline the battery lifetime. These have been mentioned in the report proposed by T. Ikeya etc. in J. of Power Sources (Vol. 69, No. 1-2) in November, 1997, and the one by H. Oman in IEEE Aerospace & Electronics Systems Magazine (Vol. 14, No. 9) in 1999. During the repeatedly charging and discharging process, if the battery is kept in the over-charge status with high current or high temperature, the materials within the battery would be passivation, consequently decreasing battery capacity, or even causing safety problem. Among the known relevant technology, the methods of fixed current, fixed voltage or pulse charge have been adopted to avoid the influence of rapid charge on safety or battery lifetime.

Since the recharge is a process that the external charge energy level struggles with the discharge energy within the battery itself, it forms the competition of energy. Generally, the lead-acid battery is in series of several single-cell batteries. However, the internal resistance of each cell is different in normal, exhaust chemical material passivation or electric leakage which then causes internal resistances between cells unblance. Therefore, the charge method only with the use the constant high current or constant pulse frequency and amplitude is hard to fit each battery cell, and also there occur the latent variables of charge efficiency and safety. In the known technologies of lead-acid battery charge, one of the method is voltage charging means to charge with a high fixed voltage in the beginning, and then to reduce the charge current when the battery voltage is gradually rising. Finially, when the current is lower than the set-point, cut it off or switch to an even lower current to maintain the consumption of the battery. The another method is current charge, means to refers to charge with the maximum set-point current, and when the battery voltage gradually rises to the set-point voltage then cut it off or switch to an even lower current to maintain the consumption of the battery. To minimize the decline to the battery during charging, the pulse charge method means to charge by positive pulse then immediately switches to the short period of negative pulse and then goes to the rest with zero current, in cycles. The another alternative pulse charge method is charging by positive pulse then rest to zero immediately, as in U.S. Pat. No. 5,670,863 and U.S. Pat. No. 6,154,011. To achieve the optimal efficiency, the cycle of pulse charge must be considered with the amplitude, frequency and idle pulse, etc, of the pulse current, which interact with the efficiency by the factors of battery type, the capacity of the battery, battery internal resistance, and the unbalance of each cell in the battery pack. Their relationships are very complicated and involve with many variables, so finding the most suitable charge curve is limited by the applicability to all different situations, as in Republic of China Patent 583408. As for the pulse charge method, the pulse current intensity, the pulse width and idle time should be considered, though there is no general rule about the relationship between these parameters and the charging efficiency. According to the experiment and research report brought forward by Proceeding of 2^{nd} Power Electric in 2003, it is difficult to prove pulse charge method has the advantage of improving charging efficiency. Moreover, the main purpose of pulse charge is to charge with rapid rate, without considering the control on the temperature, but it adopts positive-negative or positive-zero cross charge. This kind of rapid charge would accelerate the decline of the activity of the plate surface of the lead-acid battery, even result in the excessive deposit of lead sulfate, and finally shorten the lifetime of lead-acid batteries.

Because rechargeable battery are widely employed in various electronic products and mobile vehicles or ships, the problems concerning the correct and safe full-charge, and the charge methods causing no decrease in battery lifetime are always the main task for chargers. In practicle application, it remains a problem that how to select the voltage set-point or current set-point, or the mix of them to realize full and safe charge, and at the same time to keep the battery lifetime. The full charge involves the uniformity in the battery pack and the way of estimating the state of charge battery during the charge process. As for the known estimating methods of the state of charge battery, they mainly refer to voltage measurement, coulomb measurement, and the internal resistance calculation method proposed by Johnson in J. of Power Sources, 2002. The state of charge battery can also estimated by applying the monitored battery management system, such as Republic of China Patent Notice 439310, or by calculating the electric energy accumulation of the battery pack, such as U.S. Pat. No. 5,754,028, or through the control power factor to been charger, such as Republic of China Patent Notice 590327, or used periodic voltage sweeps to determine the charging voltage, such as U.S. Pat. No. 5,469,043. As for the method of calculating the electric energy accumulation, U.S. Pat. No. 6,611,128 advances the internal resistance measurement and Proceeding of 2^{nd} Power Electric propose the residual capacity measurement for batteries by Coup de Fouet characteristic in 2003. In practice, users demand a simpler and cheaper measurement which can be integrated with charge methods without complicated computer server systems.

As mentioned above, charging process, in fact, is the completion between the battery itself and the external charging energy. The energy that can be absorbed by the battery in charging process is called Battery Energy Barrier (BEB). If the external charging energy is higher than battery discharge, i.e., breaks through the BEB, then the charge can be conducted. On the other hand, if the external charging energy is lower than battery discharge, then the battery would go through discharging process. If charge the battery with energy excessively higher than BEB, then there might occur the violent reverse chemical reaction that would overly activate the battery, and perhaps cause over-high temperature in the battery, and might cause the unbalanced over-activation of a single cell, and once in a while lead to battery passivation or even explosion. If with energy lower than BEB, it is possible for the insufficient charge or overlong charge time to occur. The optimal is that provides only exactly the maximum absorbable energy that enables in charging the battery under the minimum driving force. Because there are different status, such as full charge, insufficient charge, electric leakage, passivation, unchargeable, partially passivation (one or several cells passivated, or the temporary delay due to over discharge, called as transient passivation). The result of a simple voltage measurement or current measurement cannot directly reveal the BEB between the battery pack and the charge energy. However, the use of the simple voltage measurement or current measurement or use the charge pattern to control the charge cycles is applicable for some special instances, such as Republic of China Patent 587359. Forward, the multi-stage charger has to meet the requirements of charging protection, charge method selection, charge energy control, charging current and voltage stages tuning, etc, in charging cycle. It is impossible for the multi-stage charger to be widely applicable to different situations, such as different state of charge battery or whether the battery is normal. Therefore, the charger easily causes the voltage floating and current floating, and the set-point fluctuation between the switching stages as well as the final stage. Besides, some experiment results prove that the full charging ratio is only 85% after the finish of charging cycles. The others, some rapid charge methods, without the consideration of battery absorption rate and the time need to transfer the charging energy to internal energy. Some experiment results prove that the full charge rate among their preferred embodiments is 75%, some results prove that the storage capability of the battery might rapidly decrease with the increment of charge and discharge cycles, and some results prove that the battery become passivation rapidly.

### SUMMARY OF THE INVENTION

The aspect of this invention is to provide a self-adaptive charge and diagnosis method and device with detectable BEB function, which employs the measurement method and device for the BEB during charging to improve the previous charge methods. The invention is mainly provided the BEB measurement and BEB characteristics reasoning that deduce the charger methods and charge device, and is capable of indication the status (normal or not, full-charge or not) of the battery charge. It adopts the bridge rectifying circuit of the primary power supply for charge, secondary control circuit, BEB measure and calculator control unit, and the charge and battery status display and alarm circuit. Before and in the process of charge, the BEB calculated can derive proper charge current, voltage and switch time, forming non-stage charge method, through which the charge efficiency of lead-acid battery pack can be significantly improved, the current and voltage noise during charge is greatly decreased, and the full charge ratio is efficiently promoted to be above 98%.

In another aspect, the present invention provides a self-adaptive charge and diagnosis method and device with detectable BEB function, which employs the advantage possessed by the BEB measurement and BEB characteristics reasoning to actively monitor the status of the battery pack. In the charging process deduces an adaptive current and voltage to charge, safety protection measures, to stabilize the charge speed, to set the charge termination moment and to maintenance the battery by using trickle charge, different charge methods which are adaptive to the battery status can be used to efficiently enhance battery's life cycles.

In yet another aspect, the present invention provides a self-adaptive charge and diagnosis method and device with detectable BEB function, which employs an alternative to replace the inadequate method by using the difference of voltage or current in charging, that is able to indicate the energy difference between battery and charge side. Thus, it can be widely and safely applied to normal battery, electric leakage battery, partially or fully passivation battery. Moreover, it is able to alarm and display the abnormal status of battery.

### BRIEF DESCRIPTION OF THE DRAWINGS

FIG. 1 The invention example of charger appliance

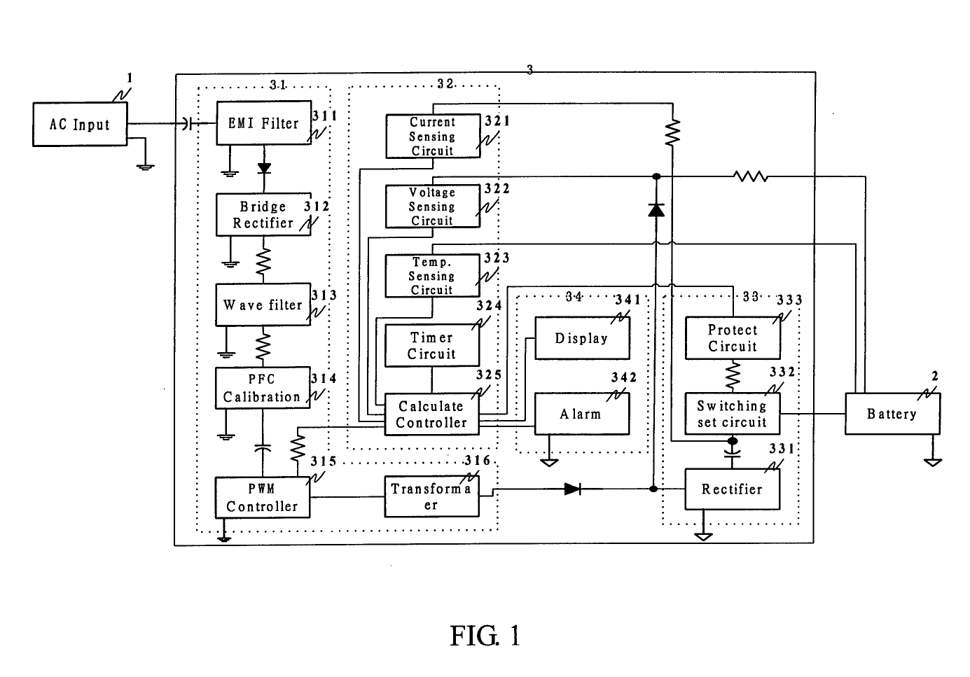

FIG. 2 Charging curve of the invention example of charger appliance;

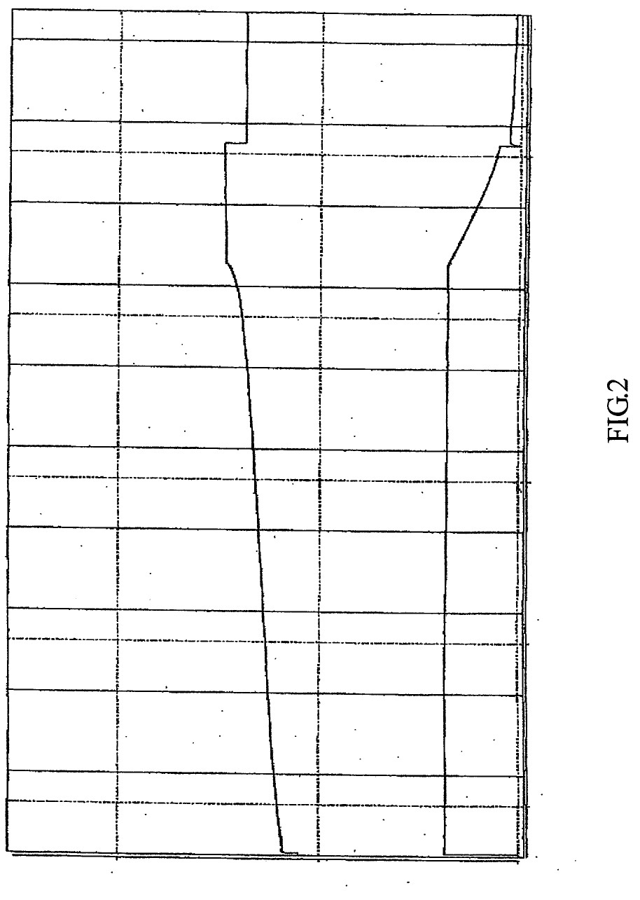

FIG. 3a Charging curve 1 of well-known charger;

FIG. 3b Charging curve 2 of well-known charger;

FIG. 4 The relationship between BEB and charging cycle

FIG. 5a The main flow chart of this invention

FIG. 5b The flow chart 1 of this invention

FIG. 5c The flow chart 2 of this invention

FIG. 5d The flow chart 3 of this invention

1: AC input terminal

2: Battery

31: Primary power supply unit

311: EMI filter circuit

312: Bridge rectifier circuit

313: Bulk cap filter

314: PFC calibration

315: PWM controller

316: Transformer

32: BEB measure and control unit

321: Current sensing circuit

322: Voltage sensing circuit

323: Temperature sensing circuit

324: Timer circuit

325: Calculate controller

33: Secondary control unit

331: Rectifier

332: Switching set circuit

333: Protect circuit

34: Alarm & display unit

341: Display

342: Alarm

V_{P}: Nominal Voltage

V(t): Current battery voltage at time t

V_{C}(t): Output voltage of charge power at time t

V₀: Initial battery voltage

V₁: Battery voltage after diffusion complete

V₂: battery voltage after polarization complete

V₃: Battery voltage after the 1^{st} charge stage finished (3-1 zone)

V₄: Battery voltage after the 2^{nd} charge stage finished (3-2 zone)

V: Initial battery voltage

T_{C}(t): Battery temperature at time t

T: Time Constant of Battery Characteristics

T₀: Initial Time

T₁: Finish time of diffusion

T₂: Finish time of polarization

T₃: Total time of the 1^{st} charge stage finished (3-1 zone)

T₄: Total time of the 2^{nd} charge stage finished (3-2 zone)

T_{oc}: Time from polarization complete to full charge

A_{P}: Nominal Current

A_{S}: Limited current

A (t): Loop current at time t

A_{C}(t): Equivalent output current of charge power at time t

A₀: Initial loop current

A₁: Loop current after diffusion complete

A₂: Loop current after polarization complete

A₃: Loop current after 1^{st} charge stage (3-1 zone)

A₄: Loop current after 2^{nd} charge stage (3-2 zone)

E_{cell}(t): Battery energy at time t

E_{c}(t): Charge energy at time t

E_{Cmax}: Maximum charge energy

E_{Q}: BEB under polarization equilibrium

E_{F}: Residual battery energy before charge

ΔE(t) : Energy difference at time t

E_{B}(t): BEB at time t

E_{B0}: Initial BEB before charge

C_{P}: Maximum full capacity of the battery

η: Charger efficiency ratio

ρ: Initial residual energy ratio (%) of battery

λ: Ratio coefficient between limited current and nominal current

ka, kb, kc, α, β, γ: Function coefficients

### DETAILED DESCRIPTION OF THE PREFFERED EMBODIMENT

Corresponding a vehicle battery system reference characters indicate corresponding method and parts throughout the several views. The exemplifications set out herein illustrate a preferred embodiment of the invention, in one form thereof, and such exemplifications are not to be construed as limiting the scope of the invention in any manner.

Lead-acid battery pack: 24 VDC-24 AH

AC input terminal: 230 VAC±10%, 50˜60 Hz

Circuit working voltage Vcc: 16 VDC

DC voltage: 400 VDC

Charger power: 24V-2 A

(1) Measurement Method for the BEB of a Preferred Embodiment of this Invention

There existing an energy gap between battery energy and charge energy, as while in charging, the input charge energy must overcomes the battery energy. As shown in the following equation:
ΔE(t)=E_{c}(t)−E_{cell}(t)
where E_{c}(t) refers to the energy supplied by the charger appliance at time t, E_{cell}(t) is the battery energy. ΔE(t)≧0 signifies that the charger output energy is higher than battery energy. If the charge current is equal to loop current, it means charge voltage goes higher than battery discharge voltage, then charging can be proceeded. But at this moment, the energy entering the battery has not been transformed to battery internal energy yet. In order to continuously transform to battery internal energy, the absorbable energy by the battery E_{B}(t), called Battery Energy Barrier (BEB), should be surpassed. BEB has different meaning in different situations: if t≦0, E_{B}(t)=E_{B0}, it is called as Initial Charging Energy; if t>0, and the battery reaches polarization equilibrium after charge starts, E_{Q} is meaning as Equilibrium BEB; as if t>0, the battery is chargeable and is able to transform the input energy into internal energy, it is E_{B}(t) at time, at polarization equilibrium point E_{B}(t)=E_{Q}. E_{B}(t) is a function of voltage, current, battery temperature, internal resistance, battery capacity, etc., and can be simplified as the function of battery characteristic coefficient, voltage, and current.

The different status are existing as perhaps empty, or half or full charged, if the lead-acid battery is normal and not seriously decline. The measured voltages are not the same, and the time periods to full-fill charge are not the same as ones. If excessively high charging energy is supplied to them, there maybe occur safety concerns, some explosion accidents thus have happened due to this. For the purpose of safe and full-fill charge, the output energy of the charger appliance is unsuitable to be over high, and otherwise, due to over high voltage, the battery temperature may rapidly rise, or the reverse chemical reaction would turn overly violent, which maybe consequently cause the passivation of the electrode and electrolyte, and the high concentration of lead sulfate. These are the reasoning of safety and full-fill concerns. Therefore, it is the most proper for the charging energy to be just a little higher than the energy absorbable and transformable to internal energy for the battery, that is, to enable the charging energy to be the closest to BEB.

(2) Relationship between Battery Characteristics and BEB During Charging

Lead-acid battery is composed of anode-cathode plate, electrolyte, partition, and battery case. The plate is generally made up of separator and active material. Separator is used not only for the active material to adhere to, but also as a electron collector; while the active material is mixed lead powder of PbO and Pb. The normal discharging reaction of lead-acid battery goes as the following chemical formula:
Anode electrode (—): Pb₍ₛ₎+HSO₄⁻→PbSO₄+H⁺+2e
Cathode electrode (+): PbO₂+3H⁺+HSO₄⁻+2e⁻→PbSO₄+2H₂O
Net reaction: Pb+PbO+2H₂SO₄→2PbSO₄+2H₂O

During battery discharge, Pb and PbO₂ on anode and cathode, together with the sulfuric acid, are persistently consumed, which would decrease the discharging potential. The battery can be enable to re-charge. The main principle of battery charge is to re-activate anode and cathode and to resume the sulfuric acid concentration level in the electrolyte to the initial one. The chemical formula of reverse reaction goes as follows:
Cathode (—): PbSO4+H⁺+2e⁻→Pb₍ₛ₎+HSO₄⁻
Anode (+): PbSO₄+2H₂O→PbO₂+3H⁺+HSO₄⁻+2e
Net reaction: 2PbSO₄+2H₂O→Pb+PbO₂+2H₂SO₄

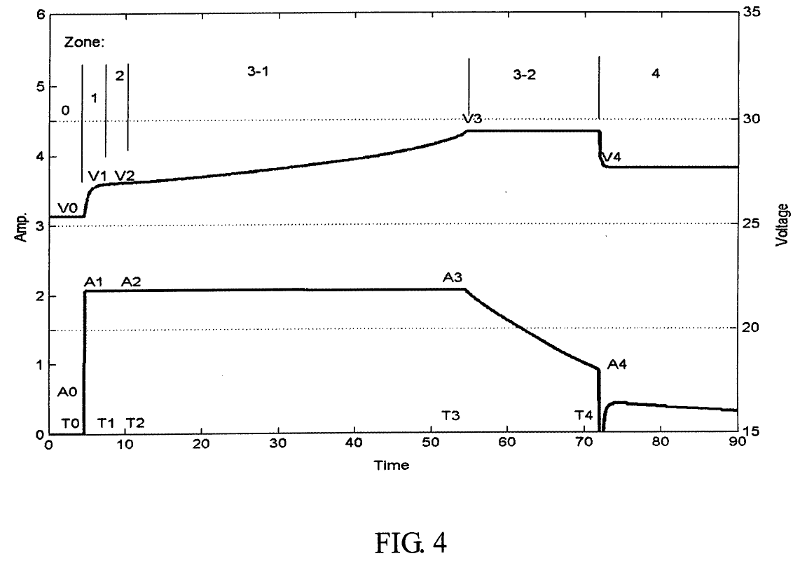

Whether a battery chemical reaction is reversible is determined by whether the external voltage is higher than the battery's pole voltage and the ability of the chemicals can be balanceable. Before charging, Pb, PbO and H₂SO₄ have been consumed, the nominal current output and voltage is reduced as comparison with the full-fill battery, for example, with 0-zone as in FIG. 4. Charging is a process of activating lead oxide (PbO) and 3PbO.PbSO₄.H₂O into active materials, lead dioxide (PbO₂) and Pb, with PbO₂ produced on anode and Pb on cathode. When the plate goes through chemical reaction, the ion concentration on its surface would change, with the PbSO₄ near the cathode diffuses to the cathode and that near the anode to anode. During the chemical reaction, PbSO₄ is transformed into Pb, PbO₂ and H₂SO₄. The diffusion determines the speed of electrode reaction, so the excessive Pb and PbO₂ due to battery passivation would extend the diffusion time, even resulting in the inability of charging reaction. If too much Pb deposits at the electrode bottom, would make the diffusion appear too quickly and take a short-cut been the internal battery shortage. Because the diffusion proceeds according to the concentration difference, at the beginning of charge, the battery bears the load higher than 0-zone's voltage from the external, then the potential difference between cathode and anode drives the reverse reaction to happen, and the neutral active materials go in nature diffuse, as illustrated in the 1^{st} zone in FIG. 4. The corresponding BEB would rise according to unit step response, as in the following equation expression:
E_{B}(t)=E_{B0}×(1−e^{-t/T})

Where E_{B0} is the BEB difference between before charging and polarization equilibrium, and T is the battery characteristic time constant. If current is fixed, the above expression can be further simplified as:
V(t)=(V₁−V₀)×(1−e^{-t/T})
(V₁−V₀) is the difference of voltages before charging and after polarization equilibrium. Diffusion proceeds with respect to the battery's material of intrinsic characteristic. For a normal battery, its diffusion coefficient should be bounded and solely depend on its composition, or only varies slightly due to the environment and electrode surface status, which is comprehensively reflected in time constant T. Therefore, the identification of time constant can easily diagnosis the battery is in passivation in partially passivation or in internal battery shortage. In the examples of this invention, the time constant of normal battery is about 20-35 seconds; that for abnormal type about 4-10 seconds, or 80-130 seconds. So it is very easy to identify the status of the battery, constituting one distinctive feature of this invention. Time constant is calculated as the following equation:

$$T = - \frac{t}{ln ( 1 - {E}_{B} ( t ) / {E}_{B 0} )}$$

Which can be further simplified as:
T=1/4(t|_{E}_{_{B}}_{(t)=0.632 E}_{_{B0}}+t|_{E}_{_{B}}_{(t)=0.95 E}_{_{B0}})

If the battery is unable to storage energy due to internal shortage or passivation, the time constant would be shorter than usually; if some single cells of the battery are partially passivation or transiently passive, the time constant would be longer than that of the normal battery.

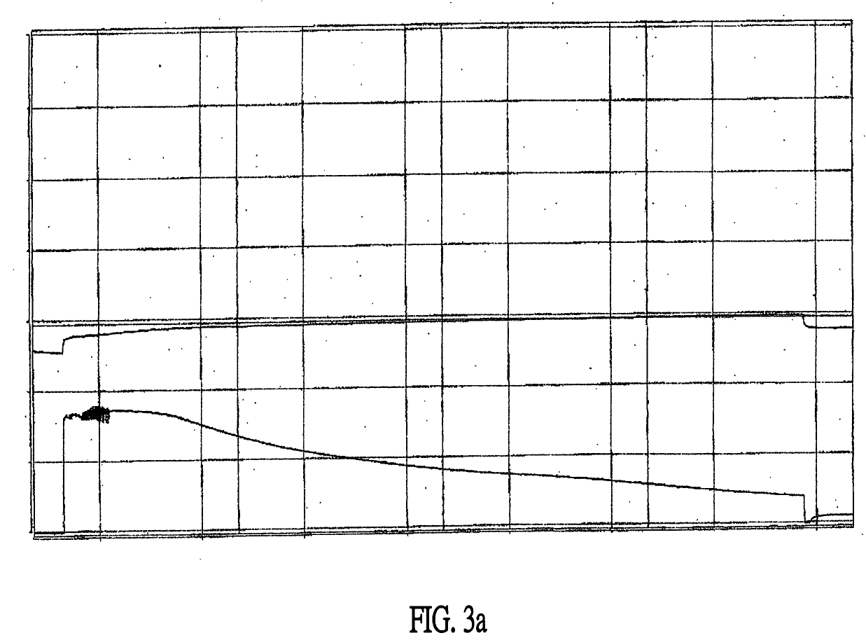

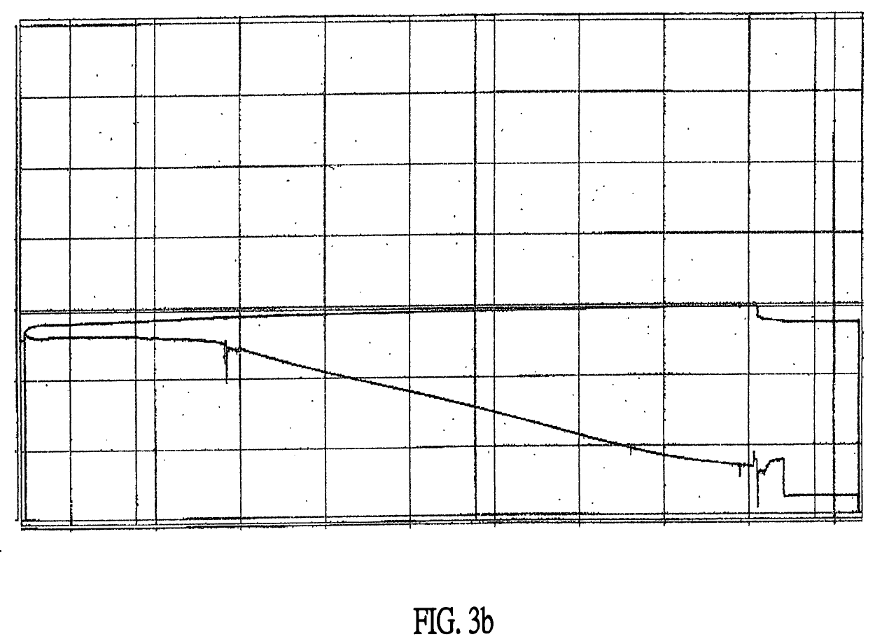

When the charging voltage keeps higher than that of the battery itself, battery electrodes would enter the polarization equilibrium stage, as shown in the 2^{nd} zone in FIG. 4, at which time the charging current density would polarize the battery plate, active materials and sulfuric acid, and etc. The polarization can be divided into three types: the first is activation polarization, in which, as the plate, active material and sulfuric acid belong to different phases, the equilibrium potential is higher than the battery potential, so as the nuclide been produced; The second type is concentration polarization, in which, for the equilibrium potential is influenced by concentration, if the current density is enough for the reactant on the surface of electrodes, the current needed by the reaction would not significantly change the battery potential; The third type is ohm polarization, in which, the potential needed by the polarization must exceed the electron stream barrier formed by the inert materials clinging to the electrode surface. When the battery is loaded by external voltage and the loaded voltage is higher than that needed by polarization, it begins the process polarization. After the ending the polarization, the resistance of battery is getting high, when the current density is keep in constant, that is, the voltage need is higher than last stage. If the active polarization is unable to complete due to insufficient active materials, or the net reaction cannot overcome the potential change due to inadequate concentration, or too much deposition of inert materials becomes a barrier for the polarization, the polarization would not be finished. In this case, the battery energy would remain unchanged, called as polarization energy E_{Q}. If the charging current is fixed, since the battery internal resistance keeps unchanged too, the voltage is unable to rise. By this principle, it can be quickly determined if the battery is normal, or of passivation or electric leakage. In the embodiments of this invention, if the battery voltage does not rise within several hours, it indicates that the internal resistance would not rise or polarization cannot be completed. It can further diagnose that the battery is normal or not. This is another unique feature of this invention. During the rise of battery internal resistance, if the charge energy and driving voltage force to the battery go higher above the energy barrier of polarization equilibrium (E_{Q}), the battery would enter into the over-charge stage, and then the charge energy would be transformed into battery internal energy, as shown in the 3^{rd} zone in FIG. 4. At the over-charge stage, over-high energy would rather cause over-high temperature, and cause the battery reverse reaction to proceed at a speed higher than those of the active material transformation or absorption, resulting in battery passivation; Insufficient or unstable energy input would also lead to the impossibility of full charge. To avoid over-high energy, the optimum charge method is to offer the energy absorbable for the battery, that is, to overcome the existing battery barrier E_{B}(t), in another word, to minimize the difference between charging energy and BEB. Since at time t during the battery charging, the chemical reaction does not immediately reach to be equilibrium, it is not possible to accurately measure BEB at any sampling time t, but can be measure BEB for last equilibrium moment only. In the preferred embodiment of this invention, the following objective function indicates the optimal charging energy output E_{c}(t),

$${E}_{C} ( t ) = {min}_{t \geq {T}_{B}} \{ f ( {E}_{C} ( t - 1 ) , {E}_{B} ( t - {T}_{B} ) ) \}$$

where T_{B}=T₂−T₁ is as illustrated in FIG. 3. In the other embodiments of this invention, to achieve the purpose of safety and the optimal efficiency during charge, the objective function for the optimal charging energy is:

$${E}_{C} ( t ) = {min}_{t \geq {T}_{B}} \{ f ( {E}_{C} ( t - 1 ) , {E}_{B} ( t - {T}_{B} ) , {T}_{OC} , ρ ) \}$$

For the normal battery, the absorbed energy E_{F} by the battery since t₀ is simplicity expression by the objective function under the constraint conditions:

$${E}_{F} = η {\int }_{t = {t}_{0}}^{t = {t}_{4}} i \cdot {A}_{C} ( t ) ⅆ t = η ( 1 - ρ ) {C}_{P}$$

Where, E_{F} is the absorbed charging energy since t₀; T_{OC} the time from polarization complete to full charge, i.e., T_{OC}=T₄−T₂; ρ the residual quantity of electricity; C_{P} the possible battery capacity of full charge; η the charger efficiency.

In measuring and calculating BEB, battery temperature, current, and voltage can be used:
E_{B}(t)=f(V(t−T_{B}),A(t−T_{B}),T_{C}(t))+E_{Q}
where, V(t) is the battery voltage at time t; A(t) is loop current at time t; T_{C}(t) is average temperature of the all battery cells; E_{Q} is BEB under polarization equilibrium:
E_{Q}=f(V(t₂),A(t₂),T_{C}(t₂))

This embodiment is example to be simplified by measuring battery voltage V(t) by circuit and loop current A(t) by circuit and adopting the specific function of the BEB calculation unit to calculate BEB. Hereby, the equation can be further simplified as follows:
E_{B}(t)=f(V(t−T_{B}),A(t−T_{B}))+E_{Q}

In the preferred embodiment, for the lead-acid battery, as shown in the 3-1 zone of FIG. 4, and the BEB can be expressed by the following time function:
E_{B}(t)=E_{Q}+α₃₁ t+β₃₁ t²
where, parameters α₃₁ and β₃₁ are relative to battery's type, capacity, concentration of the active materials, and the original residual electricity. Under the optimal charging conditions and driving voltage force, the charging energy at time t can be described by the mathematical function as follows:
ti E_{C}(t)=1/η(ka₃₁+kb₃₁A_{P}/V_{P}t+kc₃₁(A_{P}/V_{P})²t²)
whereas,
ka₃₁=E_{Q}−α₃₁T_{B}+β₃₁T_{B}T_{B}
kb₃₁=α₃₁V_{P}/A_{P}−2T_{B}β₃₁V_{P}/A_{P}
kc₃₁=β₃₁(Vₚ/A_{P})²

η is the charger efficiency. In order to simplify the calculation and control units of the charger appliance, the equation can be simplified into:
E_{C}(t)=1/η(ka₃₁+kb₃₁A_{P}/V_{P}t)

If the more simplification is need, the absorbable energy can be neglected, the equation can be further simplified as:
E_{C}(t)=1/η(E_{Q}+(V_{P}−V₀)A₂)

This is the well known technology of constant current method as in 3-2 zone of FIG. 4, it makes the battery voltage gradually rise to a preset high voltage limit.

When the charging process reaches the highest limited voltage, called as the 3^{rd} voltage V₃, because BEB begins to descend (internal resistance persistently rises). The current would begin to descend under the constraint of the voltage is constant. If BEB cannot continue to descend, perhaps shortage occurs in one or several cells of the battery, which makes it difficult to absorb the energy or leads to over-high BEB. Thus the battery status can be diagnosed by whether BEB can smoothly descend, thus forming another unique feature of this invention. As in 3-2 zone of FIG. 4, because BEB begins to descend, the charging energy also begins to descend. BEB can be represented by the following time function:
E_{B}(t)=E_{B}(t=T₃)+α₃₂ t+β₃₂ t²
whereas, α₃₂ and β₃₂ are related with the battery's type, capacity, concentration of the active materials, and the original residual energy in side. Under the optimal charging condition and driving voltage force, the charging energy output at time t can be expressed by mathematical function as follows:
E_{C}(t)=1/η(ka₃₂+kb₃₂A_{P}t+kc₃₂A_{P}²t²)
Whereas,
ka₃₂=E_{B}(t=T₃)−α₃₂T_{B}+β₃₂T_{B}T_{B}
kb₃₂=α₃₂1/A_{P}−2β₃₂T_{B}1/A_{P}
kc₃₂=β₃₂(1/A_{P})²

In order to simplify the calculation and control units of the charger appliance, the equation can be simplified into:
E_{C}(t)=1/η(ka₃₂+kb₃₂A_{P}t)

If the more simplification is need, the absorbable energy can be neglect, the equation can be further simplified as:
E_{C}(t)=1/ηE_{B}(t=T₃)

This is the well known technology of constant voltage method as in 3-3 zone of FIG. 4, it makes the battery current gradually descend to preset low current limit

The battery reaches the full charge stage after getting continuous energy from the charger appliance, and BEB also gradually descends. The chargeable energy is decrease to the minimum, and then the battery is fully charged with maximal energy, and the charging process is complete. If the charging energy is unable to descend to the preset value, perhaps battery shortage occurs in one or several cells of battery, which makes it difficult to absorb energy or leads to over high BEB. Therefore the battery status can be determined by the descending of the charging energy, which becomes another unique feature of this invention. At the period of full-fill charge stage, to avoid battery electric consumption by the external loop, the battery can be charged by very low energy to maintain the consumption; called as trickle charge, as show in the 4^{th} zone of FIG. 4. If the loop current keeps higher than the limited current As at the preset duration, it is diagnosed that the battery is abnormal. This is the further unique feature of this invention. Here the current limited, A_{S}, is set as follows:
A_{S}=λA_{P}
where, λ is a coefficient that related with battery characteristics, ranging between 0.2 and 0.25 for this embodiment. Usually, as for the battery with less energy storage capability, set the limited current higher to assure charging safety.
(3) The Preferred Embodiment of this Invention Adopting Self-Adaptive Charge Method with the Function of Detectable BEB

For the convenience of illustrating the implementation of this invention, after BEB is obtained from the simplified calculation only through the voltage and current measurement (Note the measurement is not limited to voltage and current), the charger appliance can adopt self-adaptive tuning to the output energy according to different BEB calculated and status under different situations and at different time, as illustrated in the following:

a. the battery is connected to the charger appliance to begin in charging (t<0), BEB is calculated with the following equation:
E_{B0}=f(V(t),A(t))ₜ₌₀=1/V_{P}A_{P}(V(t=0)·A(t=0))

If E_{B0}>0, it indicates the charge can be proceeded; if E_{B0}<0, it indicates the battery is oppositely polarity and the charging is unable to begin, so the charge method with safety protection is enforced;

b. after the charging process is started, the constant power output is applied. The output voltage is V_{P} and output current A_{P};

c. during the charging process is ignited, battery is forced to the diffusion of sulfuric acid and polarization. At this period the voltage begins to increase;

d. after polarization is finished, continuing to charge with the minimum BEB, e.g., the driving voltage force and charge energy is restraint by following results:

$${E}_{C} ( t ) = {min}_{t \geq {T}_{B}} \{ f ( {E}_{C} ( t - 1 ) , {E}_{B} ( t - {T}_{B} ) ) \}$$

And
E_{Cmax}=1/ηmax{E_{Bmax}}=1/ηmax{f(V₃,A_{P})}
E_{Cmin}=1/ηmin{E_{Bmin}}=1/ηmin{f(V₃,A_{P})}

In t₂<t<t₃ period, BEB is expressed by the following the time function:
E_{B}(t)=E_{Q}+α₃₁ t+β₃₁ t²

Where η is the efficiency coefficient. In this embodiment result, when η=0.90, the time function of the output energy is:

$$\begin{matrix}{E}_{C} ( t ) = \frac{1}{η} ( {ka}_{31} + {kb}_{31} \frac{{A}_{P}}{{V}_{P}} t + {{kc}_{31} ( \frac{{A}_{P}}{{V}_{P}} )}^{2} {t}^{2} ) \\ \approx \frac{1}{η} ( {V}_{2} {A}_{2} + {kb}_{31} \frac{{A}_{P}}{{V}_{P}} t + {{kc}_{31} ( \frac{{A}_{p}}{{V}_{P}} )}^{2} {t}^{2} )\end{matrix}$$

$${E}_{C max} = {γ}_{31} {V}_{3} {A}_{P}$$

whereas, kb₃₁ ranges between 0.160 and 0.179, kc₃₁ between 0.00132 and 0.00154, and γ₃₁ between 1.0 and 0.94.

In t₃<t<t₄ period, BEB is represented by the following the time function:
E_{B}(t)=E_{B}(t=T₃)+α₃₂ t+β₃₂ t²

In this embodiment, the charging output energy is:

$$\begin{matrix}{E}_{C} ( t ) = \frac{1}{η} ( {ka}_{32} + {kb}_{32} {A}_{P} t + {kc}_{32} {A}_{P}^{2} {t}^{2} ) \\ \approx \frac{1}{η} ( {E}_{B} ( t = {T}_{3} ) + {kb}_{32} {A}_{P} t + {kc}_{32} {A}_{P}^{2} {t}^{2} )\end{matrix}$$

Whereas, kb₃₂ ranges between −0.0246 and −0.023; kc₃₂ between 0.00035 and 0.000468;

e. when battery reaches full-fill charged, the charge appliance applies A(t)=0.1 A_{P} to trickle charge to keep the capacity of battery;

f. in every charging period, detect the passivation, battery shortage or damaged status and signify the alarming information.

(4) Another Embodiment of this Invention Adopting Self-Adaptive Charge Method with the Function of Detectable BEB

For the convenience to illustrate this embodiment, only with the voltage and current measurement (the measurement, however, is not limited to voltage and current), conduct the charging method with the optimal time efficiency T_{OC} as which, BEB is calculated to be the optimal constraint, as illustrated in the following:

a. the battery is connected to the charger appliance to begin in charging (t<0), BEB is calculated with the following equation:
E_{B0}=f(V(t),A(t))ₜ₌₀=1/V_{P}A_{P}(V(t=0)·A(t=0))

If E_{B0}>0, it indicates the charge can be proceeded; if E_{B0}<0, it indicates the battery is oppositely polarity and the charging is unable to begin, so the charge method with safety protection is enforced;

b. after the charging process is started, the constant power output is applied. The output voltage is V_{P} and output current A_{P};

c. during the charging process is ignited, battery is forced to the diffusion of sulfuric acid and polarization. At this period the voltage begins to increase;

d. after polarization is finished, continuing to charge with the minimum BEB, e.g., the driving voltage force, charge energy difference and the shortest T_{OC} is restraint by following results:

$${E}_{C} ( t ) = {min}_{t \geq {T}_{B}} \{ f ( {E}_{C} ( t - 1 ) , {E}_{B} ( t - {T}_{B} ) t , {T}_{OC} ) \} ,$$

and
E_{Cmax}=1/ηmax{E_{Bmax}}=1/ηmax{f(V₃,A_{P})}
E_{Cmin}=1/ηmin{E_{Bmin}}=1/ηmin{f(V₃,A_{P})}

If t₂<t<t₃, BEB is expressed by the time function as follows:
E_{B}(t)=E_{Q}+α₃₁ t+β₃₁ t²

In this embodiment, the charge energy output can be further simplified as:
E_{C}(t)=1/η(V₂A₂+kb₃₁A_{P}/V_{P}t+kc₃₁(A_{P}/Vₚ)²t²)
E_{Cmax}=γY₃₁V₃A_{P}

Example that the original residual of battery ρ=42.65%, kb₃₁ ranges between 0.1243 and 0.1485, kc₃₁ between 0.0105 and 0.0176, and γ₃₁ between 1.0 and 0.94.

If t₃<t<t₄, BEB can be described by the following time function:
E_{B}(t)=E_{B}(t=T₃)+α₃₂ t+β₃₂ t²
the charge energy output can be represented by:
E_{C}(t)=1/η(E_{B}(t=T₃)+kb₃₂A_{P}t+kc₃₂A_{P}²t²)

Example that, when original residual of battery ρ=41.35%, kb₃₂ ranges between −0.086 and −0.0318; kc₃₂ between 0.000177 and 0.00025;

e. when battery reaches full-fill charged, the charge appliance applies A(t)=0.1 A_{P} to trickle charge to keep the capacity of battery

f. in every charging period, detect the passivation, battery shortage or damaged status and signify the alarming information.

(5) The Primary Power Supply Unit 31 of Preferred Embodiment of the Charger Device:

Primary power supply unit 31 includes EMI filter circuit 311, bridge rectifier 312, bulk cap filter 313, power factor corrective calibration circuit (PFC calibration circuit) 314, pulse width module controller (PWM controller) 315, and transformer 316. When external AC input terminal 1 is in series connection, the primary power supply unit 31 would provide the circuit power with working voltage V_{CC}. Take 16 VDC as example, if V_{CC}=16 VDC, it supplies the working voltage to BEB measurement, and control unit 32 and secondary control unit 33. The external power AC input terminal 1 is connected to EMI filter circuit 311 for AC filtration, where EMI filter circuit 311 has the function to absorb shock waves of AC source, so as to prevent the damage of components when a high voltage is imposed suddenly from the external. Moreover, it has the function of filtering normal shock and common shock. Bridge rectifier 312 is made up of four rectifying diodes connected end to end and is able to rectify the sine AC to impulse shape due to the unidirectional electrical conductivity of the rectifying diodes. Inside the bulk cap filter 313 contains capacitors and inductors, which can achieve π type filtering on the impulse waveform to make it smoother. Power factor corrective calibration circuit (PFC) 314 is composed of special transistor and metal-oxide semiconductor field-effect transistor switch tube (MOSFET, shortened as MOS switch tube). When the rectified input voltage and current use the transistor to drive the MOSFET to adjust the output power factor, the special transistor does internal integral on the voltage and current, and then, according to the time change of the integral, adjusts the duty of the MOSFET pulse to regulate the wave shape of the output current and voltage, enabling the output power factor to go above 0.98. Due to the energy storage of the PFC calibartion 314, at the “off” moment of the MOSFET, the voltage rectified by bridge rectifier 312 is superposed with that emitted from the PFC calibration 314. The superposed voltage can produce a voltage with an average value 400V, and then the voltage shape is of DC type. PWM controller 315 receives this DC voltage, and through high-frequency cutting transform it into pulse voltage with high frequency. Then it is passed from primary power supply unit 31 to secondary control unit 33 through the transformer 316, and then the energy is supplied to the battery 2 for charging.

(6) The BEB Measure and Control Unit 32 of the Preferred Embodiment of this Invention:

BEB measurement and control unit 32 includes current sensing circuit 321, voltage sensing circuit 322, timer circuit 324, and calculate controller 325. Current sensing circuit 321 can measure the battery current at time t, which then be input into the calculate controller 325; timer circuit 324 receives the time counting signal from the calculate controller 325, and when the counting times up, it would output the signal to the calculate controller 325.

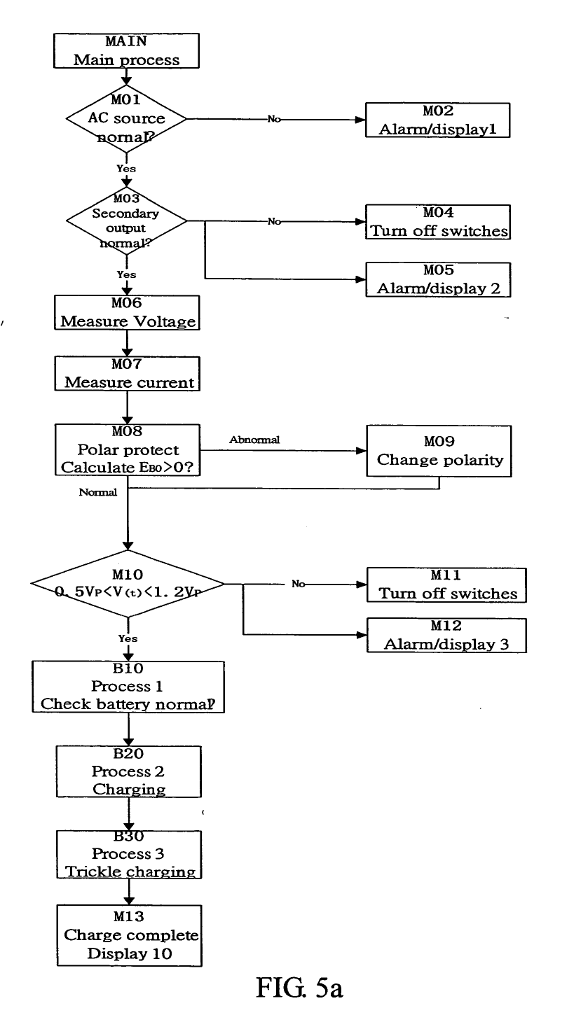

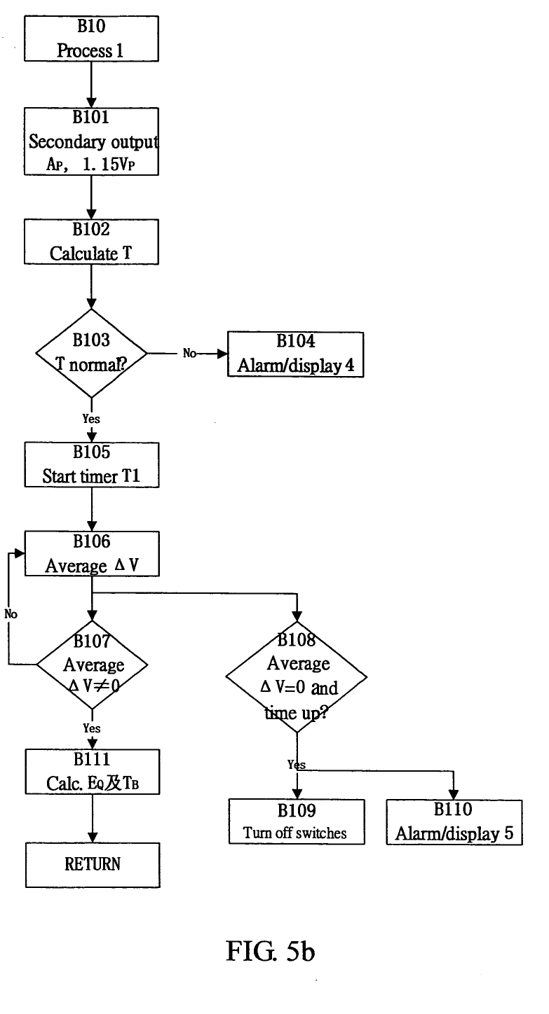

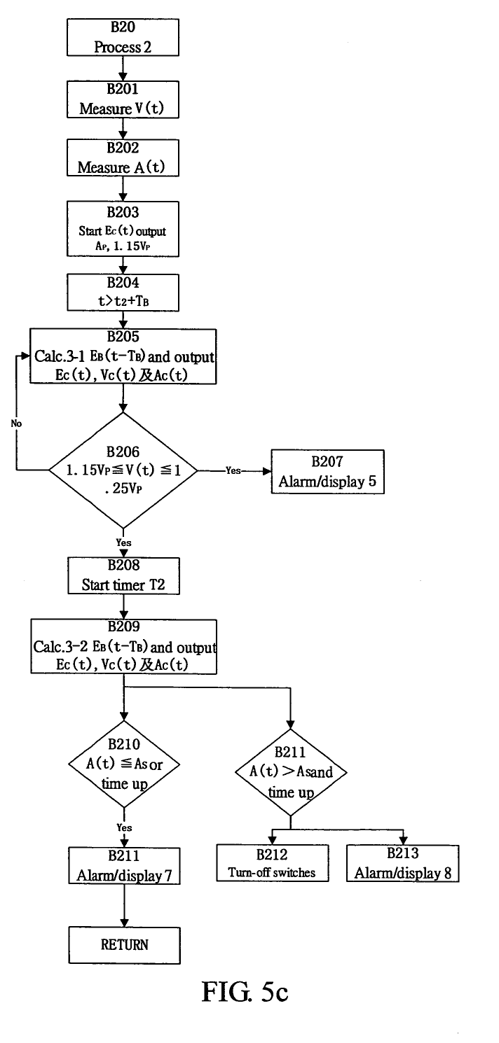

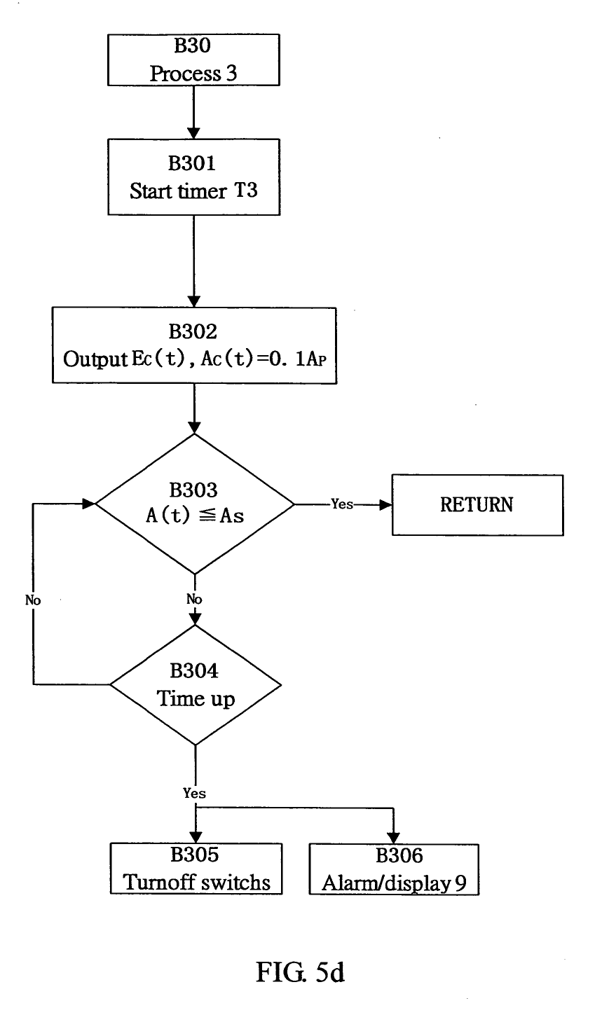

As shown in FIG. 5a-5d, the flow block diagrams concerning BEB measure, diagnosis and control methods of the preferred embodiment of this invention are presented, including the following procedures:

<1>: M01 When AC power source is connected, check whether it exceeds the limit. If yes, display the first type of alarm signal and sound the first frequency buzz.

<2>: M03 Check the status of the secondary working voltage. If it is lower than the element voltage, turn off the switch. At the same time, display the second type of alarm signal and sound the first frequency buzz.

<3>: M06, M07 Measure the current and voltage at each sampling time.

<4>: Calculate E_{B0}, if it is negative, begin polar protect. The charging process is carried out after polarity reverse.

<5>: M10 Diagnose whether the battery is normal, and it is abnormal if the voltage value is 50% lower or 20% higher than the nominal voltage. If abnormal, turn off the output switches to cutoff charging, display the third type of alarm signal and sound the first frequency buzz.

<6>: B10 Begin the diffusion and polarization of the first stage and check whether the battery is normal. If it is abnormal, display the alarm and cutoff charging output.

<7>: B20 If, after checking, the charging process can continue, calculate BEB and output charging energy to charge the battery. And alarm and display if full charge is reached.

<8>: At full-fill charge, begin trickle charge with low energy to maintain the battery capacity, and display the tenth alarm signal and sound the second frequency buzz.

The output of the charging energy is controlled by PWM controller 315 to drive the MOSFET, the charging energy is calculated by BEB and feedback signal, through PWM controller 315 to control the PWM amplitude and pulse time width, to actuate the MOSFET pulse ratio, thus control the transformer 316 to transfer to secondary control unit 33 to decrease the power output and the charging voltage will be descend; or to increase the power output and the charging voltage will be rising. For this invention, due to its simple and effective calculation of BEB and low complexity of the device, together with the frequency of pulse signal ranging about 50 KHz˜60 KHz, the processing speed for the feedback signal can be below than 0.1 msec, and then the most appropriate charge with optimal energy and full-fill charge can be achieved. When the battery is full-fill charged, the charge current can be calculated by BEB and trickle charging, the charging current can also be reduced to 1/50˜1/40 of the nominal charge for normal battery. Thus the minimum current can compensate the leakage energy to the environment and other energy consumption.

As shown in FIG. 5a-5d, the flow chart for BEB measurement, diagnosis and charge methods of this invention includes the following:

<B101>: control the charge current to be nominal current and control the charge voltage higher than nominal voltage (A_{P} & 1.2V_{P} as example). Then the battery goes in diffusion reaction.

<B102>: calculate time constant T by the response of battery voltage.

<B103>: check whether the battery time constant is normal; if not, give out the first frequency buzz and display the third type of alarm signal. Regulate the charging current to be A_{P} and voltage V₂ for charge and diagnose battery in charging process.

<B104>: if the time constant T is not normal, display the fourth type of alarm signal and sound the second frequency buzz.

<B105>: start the timer, counting down the preset time T1 for battery diagnosis. If the battery is unable to reach polarization equilibrium in T1, turn off the charge output, display the fifth type of alarm signal and sound the first frequency buzz.

<B106>: at several sampling time period, continuously measure the voltage and calculate voltage variations. If the voltage begins to rise after polarization complete, then calculate E_{B0} and T_{B}

<B203>: after the battery finishes polarization equilibrium, the charging output begins to charge with the nominal current and the fold of the nominal voltage (A_{P} and 1.15V_{P} as example).

<B205>: calculate BEB at time t-T_{B}, and E_{C}(t) according to the rule of minimize the BEB. Then derives the voltage V_{C}(t) and A_{C}(t) to the secondary control unit.

<B206>: if E_{B}(t)=E_{Bmax} or the battery voltage has reached the set voltage V₃, then display the first stage charging, alarm the sixth type of signal and sound the second frequency buzz.

<B208>: start timer, counting down T2.

<B209>: calculate BEB at t-T_{B}, and E_{C}(t) according to the rule of minimize the BEB. Then derives the voltage V_{C}(t) and A_{C}(t) to the secondary control unit.

<B210>: if the charging current descend to the set point or the time reaches T2, alarm the seventh type of signal and sound the second frequency buzz.

<B211>: diagnose the battery at T2 time's up. If the current cannot descend to the set point, alarm the eighth type of signal and sound the first frequency buzz.

<B301>: start timer, counting down T3.

<B302>: calculate the charging output E_{C}(t) for the trickle charge, example that set the charge current output to be 0.1 A_{P}, to the secondary control unit.

<B304>: diagnose the battery at T3 time's up. If the current cannot descend to the set point, alarm the ninth type of signal, sound the first frequency buzz, turn off the switch to stop charging.

<B303>: if the charging current descend to the set point, full-fill charge is realized.

(7) The Secondary Control Unit 33 of Preferred Embodiment of this Invention:

The secondary control unit 33 is mainly in providing DC power source for charging, and is composed of rectifier 331, switching set circuit 332 and protect circuit 333. While BEB measure and control unit 32 calculates the output energy and derives the corresponded charging current A_{C}(t) and charging voltage V_{C}(t) at time t. The charging current and voltage can be controlled by through rectifier 331 and switching set circuit to output the charging for battery. The protect circuit 333 of secondary control unit 33 is composed by several relays. When the polarity of battery is reversed with rectifier 331 and switching set circuit, the relay should be brow out, thus to protect the battery and charge device.

(8) The Alarm & Display Unit 34 of the Preferred Embodiment of this Invention:

Alarm and display unit 34 is composed of alarm 342 with buzzer and the display 341 with LED, and is able to receive the display and alarm signal coming from BEB measure and control unit 32. The buzzer of the alarm 342 can receive signals of different frequency and give out sound with different frequency. LED of the display 341 is able to receive different combinations of on/off signals and display the signals with different permutation and combination. The buzzer and LED can alarm and display the charging results and diagnosis results.

The above exposed figures and descriptions concerns just one embodiment of this invention, which is not limited to this invention. Other changes and modifications of the equal effect done by others familiar with this technology should be included in the scope of this applied patent.

What is claimed is:

1. A method for battery charger and diagnosis with detectable battery energy barrier comprising several measuring or a groups of measuring in a combination for battery energy barrier, said BEB measuring, for each said measuring BEB or a groups of measuring BEB, and several calculating or a groups of calculating in a combination for battery energy barrier, said calculating BEB, for each said calculating BEB or a groups of calculating BEB, wherein used to measure and calculate the BEB of lead-acid battery, wherein measuring BEB and calculating BEB used to reasoning the output charging energy, wherein said the measuring BEB and calculating BEB and reasoning comprising several procedure steps or a series of procedure steps, said reasoning procedure, wherein reasoning procedure comprising,
checking the power source connected with lead-acid battery before charging, is in the limited threshold, otherwise alarm or not and display or not;
checking the output working voltage before charging, is in the limited threshold, otherwise alarm or not and display or not;
sensing the loop current, battery voltage and temperature at the predetermined sampling time, whose the battery voltage is lower than predetermined the low limit voltage, said under-voltage, whose the battery voltage is high than predetermined the upper limit voltage, said over-voltage, cut-off the output to battery and alarm or not and display or not;
controlling output a certain energy to charge the battery and sensing the loop current, battery voltage and battery temperature at the predetermined sampling time, and measuring BEB and calculating BEB, after battery diffusion complete, calculate the time constant of the diffusion; controlling output a certain energy to charge the battery and sensing the loop current, battery voltage and battery temperature at the defined sampling time, and measuring BEB and calculating BEB, after battery polarization finished, calculate the time need of the polarization;
sensing the battery temperature and measuring BEB and calculating BEB, whose the temperature is high than predetermined temperature, calculating the trickle charging energy, and control output the trickle energy to battery;
controlling output energy to charge the battery and sensing the loop current, battery voltage and battery temperature at the predetermined sampling time, and measuring BEB and calculating BEB, calculating the output energy by maximum charging efficiency and restrained BEB, wherein output energy to battery is determined by maximum need of the battery;
alarm or not and display or not at the change of charging stages.

2. The method as claimed in claim 1, wherein the self-adaptive charge method for charging lead-acid battery, wherein the measuring BEB and calculating BEB and reasoning procedure is reduced comprising as,
while the battery is connected and before the output energy charging, measuring BEB and calculating BEB with the initial present battery voltage divided by nominal voltage, loop current by nominal current, and battery temperature by atmospheric temperature;
while the initial polarization of the battery is finished, calculating the output energy of the charging with the minimum difference between BEB and previous sampling charging energy, battery temperature slope and the shortest charging time;
whose the maximal charging output energy is limited as the energy of a fixed fold of nominal battery voltage and nominal charging current and limited the predetermined battery temperature.

3. The method as claimed in claim 2, wherein the self-adaptive charge method for charging lead-acid battery, while the initial polarization of the battery is finished, wherein the reasoning procedure can be simplified as, the output energy is reasoning by using the first-order relation with charging time, the equations as follows:
during the stage from polarization finished to the upper limit battery voltage, the calculating BEB, E_{B}(t) can be expressed by the equation
E_{B}(t)=E_{Q}+α₃₁ t+β₃₁ t²,
and while the charging energy output E_{c}(t) is simplified to
E_{C}(t)=1/η(ka₃₁+kb₃₁A_{P}/V_{P}t),
where the coefficient is:
0.9 E_{Q}≦ka₃₁≦E_{Q}
(α₃₁−2T_{B}β₃₁)V_{P}/A_{P}≦kb₃₁≦α₃₁V_{P}/A_{P}
when the battery voltage rise to the upper limit and current descend to the minimum, the calculating BEB, E_{B}(t) can be described by the equation
E_{B}(t)=E_{B}(t=T₃)+α₃₂ t+β₃₂ t²,
and while the charging energy output E_{c}(t) is simplified to
E_{C}(t)=1/η(ka₃₂+kb₃₂A_{P}t),
the coefficient is:
0.9 E_{B}(t=T₃)≦ka₃₂≦E_{B}(t=T₃)
(α₃₂−2T_{B}β₃₂)1/A_{P}≦kb₃₂≦α₃₂1/A_{P}
and limited the predetermined battery temperature;
whereas, V_{P} is battery's nominal voltage; A_{P} nominal current; T₃ the time need when the battery voltage rise to the upper limit is completed, said first charging stage; T_{B} the time from diffusion to the complete polarization; η the charger efficiency constant.

4. The method as claimed in claim 2, wherein the self-adaptive charge method for charging lead-acid battery, the output energy E_{c}(t) is reasoning by using the following:
while after polarization finished, setting the BEB to the lower limit, charging energy to the maximum limit, employ predetermined loop current and upper limit voltage to charge, wherein the upper limit voltage is calculated as fixed ratio fold of battery nominal voltage;
while the battery reaches the upper limit voltage, then setting the BEB to the lower limit, charging energy to the maximum limit, employ un-fixed loop current and limited the predetermined battery temperature to charge.

5. The method as claimed in claim 4, wherein the self-adaptive charge method for charging lead-acid battery, wherein the reasoning procedure can be simplified as,
while after polarization finished, setting the BEB E_{B}(t)=a₃₁, whose coefficient is 1.0 E_{Q}≦a₃₁≦1.23 E_{Q} threshold, current is A_{P}, the upper limit for charging voltage V₃;
while the battery reaches the upper limit voltage, set BEB E_{B}(t)=a₃₂, whose coefficient is 1.0 V₃×A₃≦a₃₂≦1.15 V₃×A₃ threshold; charge with V₃ and unlimited loop current and limited the predetermined battery temperature;
whereas, E_{Q} stands for BEB under charge equilibrium status, V₃ and A₃ for the battery voltage and loop current when the 1^{st} stage is finished.

6. The method as claimed in claim 1, wherein the self-adaptive charge method for charging lead-acid battery, whose calculating the time constant of the diffusion can be further simplified as, use the step response of (V₁−V₀) to get the time constant through battery voltage rise, where V₀ is the initial battery voltage, V₁ the battery voltage at complete diffusion.

7. The method as claimed in claim 6, wherein the self-adaptive charge method for charging lead-acid battery, whose calculating the time constant of the diffusion use the step response can be further simplified as:
calculating with following any one value or the following two values average; the time for the battery voltage to reach 0.632(V₁−V₀) threshold; or one fourth of the sum of time battery voltage to reach 0.632(V₁−V₀) threshold plus that to reach 0.95(V₁−V₀) threshold;
whereas, V₀ is initial battery voltage, V₁ the battery voltage at complete diffusion, V₂ the voltage at polarization finished.

8. The method as claimed in claim 1, wherein the self-adaptive charge method for charging lead-acid battery, whose the measuring BEB and calculating BEB and reasoning with the following method:
while the battery is connected with charger before charging calculating BEB with the initial battery voltage divided by nominal voltage, and loop current by nominal current; as;
while the polarization is complete, calculating the output energy of the charging with the minimum difference between BEB and charging energy; the maximal energy output is the fixed fold of battery's nominal voltage and current and limited the predetermined battery temperature;
whose the maximal output energy is the fixed fold of battery's nominal voltage and current.

9. The method as claimed in claim 8, wherein the self-adaptive charge method for charging lead-acid battery, whose the measuring BEB and calculating BEB and reasoning can be simplified as the first-order relation between charging energy and time;
while the polarization is complete and battery voltage rising to the upper limit, BEB E_{B}(t) can be expressed by the equation
E_{B}(t)=E_{Q}+α₃₁ t+β₃₁ t²,
and the energy output E_{c}(t) is simplified into
E_{C}(t)=1/η(ka₃₁+kb₃₁A_{P}/V_{P}t),
whose coefficient is:
0.9 E_{Q}≦ka₃₁≦E_{Q}
(α₃₁−2T_{B}β₃₁)V_{P}/A_{P}≦kb₃₁≦α₃₁V_{P}/A_{P}
while the battery voltage rising to the upper limit and current descend to the minimum, BEB E_{B}(t) can be described by the equation
E_{B}(t)=E_{B}(t=T₃)+α₃₂ t+β₃₂ t²,
and the output energy E_{c}(t) is simplified to
E_{C}(t)=1/η(ka₃₂+kb₃₂A_{P}t),
whose coefficient is:
0.9 E_{B}(t=T₃)≦ka₃₂≦E_{B}(t=T₃)
(α₃₂−2T_{B}β₃₂)1/A_{P}≦kb₃₂≦α₃₂1/A_{P}
whereas, V_{P} is battery's nominal voltage; A_{P} nominal current; T₃ the time need when the battery voltage rise to the upper limit is completed, said first charging stage; T_{B} the time from diffusion to the complete polarization; η the charger efficiency constant.

10. The method as claimed in claim 8, wherein the self-adaptive charge method for charging lead-acid battery, whose the measuring BEB and calculating BEB and reasoning can be simplified as the following:
while the polarization is complete and battery voltage rising to the upper limit, setting the BEB to the minimum limit, output energy to the maximal limit to the output energy; in other words, employ a fixed loop current, and employ a fixed charging voltage that the voltage is higher than the maximal battery voltage;
whose the maximal output energy is the energy of reached the fixed fold of battery's nominal voltage; while the battery voltage rising to the upper limit, setting BEB to the minimum limit and output energy to the maximal limit, that is, to further charge by keeping the highest voltage and unfixed loop current and limited the predetermined battery temperature.

11. The method as claimed in claim 10, wherein the self-adaptive charge method for charging lead-acid battery, whose about the calculation of the energy barrier, the calculation of the output energy E_{c}(t) and BEB E_{B}(t) can be simplified as the following:
while the battery polarization finished, setting the BEB E_{B}(t)=a₃₁, to be the output energy, whose coefficient is 1.0 E_{Q}≦a₃₁≦1.23 E_{Q}threshold, the current is A_{P}, the upper limit for charging voltage V₃;
while the battery reaches the upper limit voltage, setting BEB E_{B}(t)=a₃₂, to be the output energy, whose coefficient is 1.0 V₃×A₃≦a₃₂≦1.15 V₃×A₃ threshold; charge with V₃ and unfixed loop current and limited the predetermined battery temperature;
whereas, E_{Q} stands for BEB under charge equilibrium status, V₃ and A₃ for the battery voltage and loop current when the 1^{st} stage is finished.

12. A method for battery charger and diagnosis with detectable battery energy barrier comprising several measuring or a groups of measuring in a combination for battery energy barrier, said BEB measuring, for each said measuring BEB or a groups of measuring BEB, and several calculating or a groups of calculating in a combination for battery energy barrier, said calculating BEB, for each said calculating BEB or a groups of calculating BEB, wherein used to measure and calculate the BEB of lead-acid battery, wherein measuring BEB and calculating BEB used to reasoning the output charging energy, wherein said the measuring BEB and calculating BEB and reasoning comprising several procedure steps or a series of procedure steps, said reasoning procedure, wherein reasoning procedure comprising,
checking the power source connected with lead-acid battery before charging, is in the limited threshold, otherwise alarm or not and display or not;
checking the output working voltage before charging, is in the limited threshold, otherwise alarm or not and display or not;
sensing the loop current, battery voltage at the predetermined sampling time, whose the battery voltage is lower than predetermined the low limit voltage, said under-voltage, whose the battery voltage is high than predetermined the upper limit voltage, said over-voltage, cut-off the output to battery and alarm or not and display or not;
controlling output a certain energy to charge the battery and sensing the loop current, battery voltage at the predetermined sampling time, and measuring BEB and calculating BEB, after battery diffusion complete, calculate the time constant of the diffusion;
controlling output a certain energy to charge the battery and sensing the loop current, battery voltage at the defined sampling time, and measuring BEB and calculating BEB, after battery polarization complete, calculate the time need of the polarization;
measuring BEB and calculating BEB, according to sensing battery voltage and sensing loop current at the predetermined sampling time, calculating the output energy by maximum charging efficiency and restrained BEB, wherein output energy to battery is determined by maximum need of the battery, calculating the output energy and in term of charging voltage and charging current;
calculating the trickle output energy, charge by a fixed current;
alarm or not and display or not at the change of charging stages;
whose the BEB at time t is calculated the combination of battery voltage, loop current at polarization finished and battery voltage, loop current at time t.

13. The method as claimed in claim 12, wherein the self-adaptive charge method for charging lead-acid battery, wherein the measuring BEB and calculating BEB and reasoning procedure is reduced comprising as,
while the battery is connected and before the output energy charging, measuring BEB and calculating BEB with the initial present battery voltage divided by nominal voltage, loop current by nominal current;
while the initial polarization of the battery is finished, calculating the output energy of the charging with the minimum difference between BEB and previous sampling charging energy and the shortest charging time;
whose the maximal charging output energy is limited as the energy of a fixed fold of nominal battery voltage and nominal charging current.

14. The method as claimed in claim 13, wherein the self-adaptive charge method for charging lead-acid battery, while the initial polarization of the battery is finished, wherein the reasoning procedure can be simplified as, the output energy is reasoning by using the first-order relation with charging time, the equations as follows:
during the stage from polarization finished to the upper limit battery voltage, the calculating BEB, E_{B}(t) can be expressed by the equation
E_{B}(t)=E_{Q}+α₃₁ t+β₃₁ t²,
and while the charging energy output E_{c}(t) is simplified to
E_{C}(t)=1/η(ka₃₁+kb₃₁A_{P}/V_{P}t),
where the coefficient is:
0.9 E_{Q}≦ka₃₁≦E_{Q}
(α₃₁−2T_{B}β₃₁)V_{P}/A_{P}≦kb₃₁≦α₃₁V_{P}/A_{P}
when the battery voltage rise to the upper limit and current descend to the minimum, the calculating BEB, E_{B}(t) can be described by the equation E_{B}(t)=E_{B}(t=T₃)+α₃₂ t+β₃₂ t², and while the charging energy output E_{c}(t) is simplified to
E_{C}(t)=1/η(ka₃₂+kb₃₂A_{P}t),
the coefficient is:
0.9 E_{B}(t=T₃)≦ka₃₂≦E_{B}(t=T₃)
(α₃₂−2T_{B}β₃₂)1/A_{P}≦kb₃₂≦α₃₂1/A_{P}
whereas, V_{P} is battery's nominal voltage; A_{P} nominal current; T₃ the time need when the battery voltage rise to the upper limit is completed, said first charging stage; T_{B} the time from diffusion to the complete polarization; η the charger efficiency constant.

15. The method as claimed in claim 13, wherein the self-adaptive charge method for charging lead-acid battery, the output energy E_{c}(t) is reasoning by using the following: while after polarization finished, setting the BEB to the lower limit, charging energy to the maximum limit, employ predetermined loop current and upper limit voltage to charge, wherein the upper limit voltage is calculated as fixed ratio fold of battery nominal voltage;
while the battery reaches the upper limit voltage, then setting the BEB to the lower limit, charging energy to the maximum limit, employ un-fixed loop current to charge.

16. The method as claimed in claim 15, wherein the self-adaptive charge method for charging lead-acid battery, wherein the reasoning procedure can be simplified as, while after polarization finished, setting the BEB E_{B}(t)=a₃₁, whose coefficient is 1.0 E_{Q}≦a₃₁≦1.23 E_{Q} threshold, current is A_{P}, the upper limit for charging voltage V₃;
while the battery reaches the upper limit voltage, set BEB E_{B}(t)=a₃₂, whose coefficient is 1.0 V₃×A₃≦a₃₂≦1.15 V₃×A₃ threshold; charge with V₃ and unlimited loop current;
whereas, E_{Q}stands for BEB under charge equilibrium status, V₃ and A₃ for the battery voltage and loop current when the 1^{st} stage is finished.

17. The method as claimed in claim 12, wherein the self-adaptive charge method for charging lead-acid battery, whose calculating the time constant of the diffusion can be further simplified as: use the step response of (V₁−V₀) to get the time constant through battery voltage rise, where V₀ is the initial battery voltage, V₁ the battery voltage at complete diffusion.

18. The method as claimed in claim 6, wherein the self-adaptive charge method for charging lead-acid battery, whose calculating the time constant of the diffusion use the step response can be further simplified as:
calculating with following any one value or the following two values average; the time for the battery voltage to reach 0.632(V₁−V₀) threshold; or one fourth of the sum of time battery voltage to reach 0.632(V₁−V₀) threshold plus that to reach 0.95(V₁−V₀) threshold;
whereas, V₀ is initial battery voltage, V₁ the battery voltage at complete diffusion, V₂ the voltage at polarization finished.

19. The method as claimed in claim 12, wherein the self-adaptive charge method for charging lead-acid battery, whose the measuring BEB and calculating BEB and reasoning with the following method:
while the battery is connected with charger before charging calculating BEB with the initial battery voltage divided by nominal voltage, and loop current by nominal current as;
while the polarization is complete, calculating the output energy of the charging with the minimum difference between BEB and charging energy; the maximal energy output is the fixed fold of battery's nominal voltage and current;
whose the maximal output energy is the fixed fold of battery's nominal voltage and current.

20. The method as claimed in claim 19, wherein the self-adaptive charge method for charging lead-acid battery, whose the measuring BEB and calculating BEB and reasoning can be simplified as the first-order relation between charging energy and time;
while the polarization is complete and battery voltage rising to the upper limit, BEB E_{B}(t) can be expressed by the equation
E_{B}(t)=E_{Q}+α₃₁ t+β₃₁ t²,
and the energy output E_{c}(t) is simplified into
E_{C}(t)=1/η(ka₃₁+kb₃₁A_{P}/V_{P}t),
whose coefficient is:
0.9 E_{Q}≦ka₃₁≦E_{Q}
(α₃₁−2T_{B}β₃₁)V_{P}/A_{P}≦kb₃₁≦α₃₁V_{P}/A_{P}
while the battery voltage rising to the upper limit and current descend to the minimum, BEB E_{B}(t) can be described by the equation
E_{B}(t)=E_{B}(t=T₃)+α₃₂ t+β₃₂ t²,
and the output energy E_{c}(t) is simplified to
E_{C}(t)=1/η(ka₃₂+kb₃₂A_{P}t),
whose coefficient is:
0.9 E_{B}(t=T₃)≦ka₃₂≦E_{B}(t=T₃)
(α₃₂−2T_{B}β₃₂)1/A_{P}≦kb₃₂≦α₃₂1/A_{P}
whereas, V_{P} is battery's nominal voltage; A_{P} nominal current; T₃ the time need when the battery voltage rise to the upper limit is completed, said first charging stage; T_{B} the time from diffusion to the complete polarization; η the charger efficiency constant.

21. The method as claimed in claim 20, wherein the self-adaptive charge method for charging lead-acid battery, whose the measuring BEB and calculating BEB and reasoning can be simplified as the following:
while the polarization is complete and battery voltage rising to the upper limit, setting the BEB to the minimum limit, output energy to the maximal limit to the output energy; in other words, employ a fixed loop current, and employ a fixed charging voltage that the voltage is higher than the maximal battery voltage;
whose the maximal output energy is the energy of reached the fixed fold of battery's nominal voltage; while the battery voltage rising to the upper limit, setting BEB to the minimum limit and output energy to the maximal limit, that is, to further charge by keeping the highest voltage and unfixed loop current.

22. The method as claimed in claim 21, wherein the self-adaptive charge method for charging lead-acid battery, whose about the calculation of the energy barrier, the calculation of the output energy E_{c}(t) and BEB E_{B}(t) can be simplified as the following:
while the battery polarization finished, setting the BEB E_{B}(t)=a₃₁, to be the output energy, whose coefficient is 1.0 E_{Q}≦a₃₁≦1.23 E_{Q} threshold, the current is A_{P}, the upper limit for charging voltage V₃;
while the battery reaches the upper limit voltage, setting BEB E_{B}(t)=a₃₂, to be the output energy, whose coefficient is 1.0 V₃×A₃≦a₃₂≦1.15 V₃×A₃ threshold; charge with V₃ and unfixed loop current;
whereas, E_{Q} stands for BEB under charge equilibrium status, V₃ and A₃ for the battery voltage and loop current when the 1^{st} stage is finished.

23. A diagnosis method for battery charger and diagnosis with detectable battery energy barrier comprising the measuring BEB and calculating BEB, according to claim 1, wherein said the diagnosis by using measuring BEB and calculating BEB comprising any one procedure step or several procedure steps or any combination of procedure steps, said diagnosis procedure, wherein diagnosis procedure comprising,
calculating the initial BEB, if it is negative, commanding an output to the protect circuit for polarity protection, and charging the battery after polar has changed to correct polarity;
sensing the battery voltage to diagnosis the battery is malfunctioned or abnormal or the charger is not suitable, wherein the battery voltage is lower than the predetermined low battery voltage, then turn off the charging output energy, and give out alarm or alarm with buzz;
sensing the battery voltage to diagnosis the battery is already fully charged or the charger is not suitable, wherein the battery voltage is higher than the predetermined upper battery voltage, then turn off the charging output energy, and give out alarm or alarm with buzz;
calculating the time constant after battery diffusion finished to diagnosis the one or several cell of the battery pack is of shortage or passivation, wherein the time constant is higher than predetermined time or is lower than predetermined time, give out alarm or alarm with buzz, or cut off the output energy;
starting timer to diagnosis one or several cells of the battery pack is of shortage or passivation; wherein the time need to achieve polarization equilibrium finished is longer than predetermined time, give out alarm or alarm with buzz, or cut off the output energy;
detecting the battery temperature to diagnosis the insufficiency of active materials of one or several cells of the battery pack, wherein the battery temperature is higher than the preset temperature, give out alarm or alarm with buzz, or cut off the output energy;
starting timer to diagnosis one or several cells of the battery pack is unable to be charged or is unable to discharge, wherein the battery voltage can not achieve the predetermined voltage value in the predetermined time, give out alarm or alarm with buzz, or cut off the output energy;
starting timer to diagnosis one or several cells of the battery pack is unable to be charged or is unable to discharge, wherein the loop current can not descend to the predetermined current value in the predetermined time, give out alarm or alarm with buzz, or cut off the output energy;
starting timer to diagnosis one or several cells of the battery pack has electrical leakage even the battery can discharge and charge, wherein the loop current can not descend to the predetermined current value in the predetermined time in trickle charge period, give out alarm or alarm with buzz, or cut off the output energy.

24. The diagnosis method as claimed in claim 23, to diagnosis one or several cells of the battery pack is normal, give out alarm or alarm with buzz, or cut off the output energy; whose the diagnosis method employs the calculation of the time constant of the battery diffusion, wherein the time constant is lower than the predetermined first value or higher than the predetermined second value, whose the first value can be between 18 and 25 seconds threshold, the second between 40 and 60 seconds threshold.

25. The diagnosis method as claimed in claim 23, to diagnosis one or several cells of the battery pack is normal in the trickle charging period by using starting trickle charging time, wherein the loop current can not descend to the predetermined current value in the predetermined time in trickle charge period, whose the predetermined current value is 0.9˜1.1 A threshold.

26. A diagnosis method for battery charger and diagnosis with detectable battery energy barrier, comprising the measuring BEB and calculating BEB, as claimed in claim 12, wherein said the diagnosis by using measuring BEB and calculating BEB comprising any one procedure step or several procedure steps or any combination of procedure steps, said diagnosis procedure, wherein diagnosis procedure comprising,
calculating the initial BEB, if it is negative, commanding an output to the protect circuit for polarity protection, and charging the battery after polar has changed to correct polarity;
sensing the battery voltage to diagnosis the battery is malfunctioned or abnormal or the charger is not suitable, wherein the battery voltage is lower than the predetermined low battery voltage, then turn off the charging output energy, and give out alarm or alarm with buzz;
sensing the battery voltage to diagnosis the battery is already fully charged or the charger is not suitable, wherein the battery voltage is higher than the predetermined upper battery voltage, then turn off the charging output energy, and give out alarm or alarm with buzz;
calculating the time constant after battery diffusion finished to diagnosis the one or several cell of the battery pack is of shortage or passivation, wherein the time constant is higher than predetermined time or is lower than predetermined time, give out alarm or alarm with buzz, or cut off the output energy;
starting timer to diagnosis one or several cells of the battery pack is of shortage or passivation; wherein the time need to achieve polarization equilibrium finished is longer than predetermined time, give out alarm or alarm with buzz, or cut off the output energy;
starting timer to diagnosis one or several cells of the battery pack is unable to be charged or is unable to discharge, wherein the battery voltage can not achieve the predetermined voltage value in the predetermined time, give out alarm or alarm with buzz, or cut off the output energy;
starting timer to diagnosis one or several cells of the battery pack is unable to be charged or is unable to discharge, wherein the loop current can not descend to the predetermined current value in the predetermined time, give out alarm or alarm with buzz, or cut off the output energy;
starting timer to diagnosis one or several cells of the battery pack has electrical leakage even the battery can discharge and charge, wherein the loop current can not descend to the predetermined current value in the predetermined time in trickle charge period, give out alarm or alarm with buzz, or cut off the output energy.

27. The diagnosis method as claimed in claim 26, to diagnosis one or several cells of the battery pack is normal, give out alarm or alarm with buzz, or cut off the output energy; whose the diagnosis method employs the calculation of the time constant of the battery diffusion, wherein the time constant is lower than the predetermined first value or higher than the predetermined second value, whose the first value can be between 18 and 25 seconds threshold, the second between 40 and 60 seconds threshold.

28. The diagnosis method as claimed in claim 23, to diagnosis one or several cells of the battery pack is normal in the trickle charging period by using starting trickle charging time, wherein the loop current can not descend to the predetermined current value in the predetermined time in trickle charge period, whose the predetermined current value is 0.9˜1.1 A threshold.

29. A device for battery charger and diagnosis with detectable battery energy barrier comprising,
charging method means as claimed in claim 1, whose utilize the measuring BEB and calculating BEB to reason the output energy to charge a battery;
diagnosis method means as claimed in claim 23, whose utilize the measuring BEB and calculating BEB to diagnose the battery;
primary power supply unit 31 means to transform AC to DC and control the output charging power, including means:
EMI filtration circuit 311, which can prevent the damage caused by the surging of the external AC power, including means: surging absorber which can absorb the voltage surging of external power source prevents the damage of the circuit components by high voltage is imposed from the external, normal choke filtering circuit which employs some capacitors to filter the normal choke from external power source, common choke filtering circuit which employs one or some capacitors to filter the common choke from external power source;
bridge rectifier 312, which can transform the sine AC power to pulse power;
bulk cap filter 313, which is able to make smoother the pulse type power transformed through bridge rectifier 312 to become DC power;
power factor calibration circuit (PFC calibrator) 314, used to adjust the power factor of the output power, i.e., the phase adjustment of the voltage and current wave, to reduce the reactive power and increase the real power, and then to improve the efficiency of the output power;
pulse width module controller (PWM controller) 315, which includes MOSFET and service circuit, regulates the duty ratio of the pulse according to the control signal from BEB measure and control unit 32, to regulate and transfer into high frequency pulse signals, and introduce to the transformer 316;
transformer 316, used to receive and transform the high frequency pulse signals from PWM controller 315 and then transform to power to introduce to the secondary control unit 33;
BEB measure and control unit 32 means to measure and calculate battery energy barrier and reason the suitable charging output energy and diagnose the status of battery, including means:
current sensing circuit 321, used to sense the loop current during charge and input it into calculate controller 325;
voltage sensing circuit 322, used to sense the battery voltage and input it into calculate controller 325;
temperature sensing circuit 323, by through the temperature sensor mounted on battery and able to receive temperature signals to measure the battery's temperature then inputted into calculate controller 325;
timer circuit 324, able to receive the control signal from calculate controller 325 to reset and count down;
calculate controller 325, which can receive the current value outputted from current sensing circuit 321, the voltage value outputted from voltage sensing circuit 322, and the temperature value outputted from temperature sensing circuit 323, output the timing time signal to timer circuit 324, receive the output signal from timer circuit 324, output control signal to primary power supply unit 31, secondary control unit 33 and alarm & display unit 34, calculate the initial BEB and BEB by predetermined sampling time during charge, and reason the suitable output energy amplitude, and diagnose the battery into alarm signals;
secondary control unit 33 means to control DC output energy, including means:
rectifier 331, receive and amplify the DC from primary power supply unit 31;
switch set circuit 332, controlled to on/off output to battery;
protect circuit 333, including several relay switches, which, when receive the control signal from BEB measure and control unit 32, if the BEB value is determined the battery polarity the same as that outputted from rectifier 331 and switch set circuit 332, would be output power correctly, otherwise, cutoff output to protect the battery and charger appliance when the value from BEB is determined the polarity is reverse;
alarm & display unit 34 means to display and alarm the charge status and diagnose result, including means:
display 341, composed of, but not limited to, one or several groups of LED lights which can display the diagnosis results and charging status;
alarm 342, which can sound buzz with different frequency to alarm the diagnosis results and charging status.

30. The device as claimed in claim 29, wherein the protect circuit 333 of the secondary control unit 33 is used to detect the battery polarity by use circuit polarity; when the rectifier 331 polarity is the same as battery polarity, the protect circuit 333 would turn on and drive the switch set circuit 332 to output energy to the charge, otherwise, cutoff the output.

31. The device as claimed in claim 29, wherein the display 341 can be composed of LCD.

32. A device for battery charger and diagnosis with detectable battery energy barrier comprising,
charging method means as claimed in claim 12, whose utilize the measuring BEB and calculating BEB to reason the output energy to charge a battery;
diagnosis method means as claimed in claim 26, whose utilize the measuring BEB and calculating BEB to diagnose the battery;
primary power supply unit 31 means to transform AC to DC and control the output charging power, including means:
EMI filtration circuit 311, which can prevent the damage caused by the surging of the external AC power, including means: surging absorber which can absorb the voltage surging of external power source prevents the damage of the circuit components by high voltage is imposed from the external, normal choke filtering circuit which employs some capacitors to filter the normal choke from external power source, common choke filtering circuit which employs one or some capacitors to filter the common choke from external power source;
bridge rectifier 312, which can transform the sine AC power to pulse power;
bulk cap filter 313, which is able to make smoother the pulse type power transformed through bridge rectifier 312 to become DC power;
power factor calibration circuit (PFC calibrator) 314, used to adjust the power factor of the output power, i.e., the phase adjustment of the voltage and current wave, to reduce the reactive power and increase the real power, and then to improve the efficiency of the output power;
pulse width module controller (PWM controller) 315, which includes MOSFET and service circuit, regulates the duty ratio of the pulse according to the control signal from BEB measure and control unit 32, to regulate and transfer into high frequency pulse signals, and introduce to the transformer 316;
transformer 316, used to receive and transform the high frequency pulse signals from PWM controller 315 and then transform to power to introduce to the secondary control unit 33;
BEB measure and control unit 32 means to measure and calculate battery energy barrier and reason the suitable charging output energy and diagnose the status of battery, including means:
current sensing circuit 321, used to sense the loop current during charge and input it into calculate controller 325;
voltage sensing circuit 322, used to sense the battery voltage and input it into calculate controller 325;
timer circuit 324, able to receive the control signal from calculate controller 325 to reset and count down;
calculate controller 325, which can receive the current value outputted from current sensing circuit 321, the voltage value outputted from voltage sensing circuit 322, output the timing time signal to timer circuit 324, receive the output signal from timer circuit 324, output control signal to primary power supply unit 31, secondary control unit 33 and alarm & display unit 34, calculate the initial BEB and BEB by predetermined sampling time during charge, and reason the suitable output energy amplitude, and diagnose the battery into alarm signals;
secondary control unit 33 means to control DC output energy, including means:
rectifier 331, receive and amplify the DC from primary power supply unit 31;
switch set circuit 332, controlled to on/off output to battery;
protect circuit 333, including several relay switches, which, when receive the control signal from BEB measure and control unit 32, if the BEB value is determined the battery polarity the same as that outputted from rectifier 331 and switch set circuit 332, would be output power correctly, otherwise, cutoff output to protect the battery and charger appliance when the value from BEB is determined the polarity is reverse;
alarm & display unit 34 means to display and alarm the charge status and diagnose result, including means:
display 341, composed of, but not limited to, one or several groups of LED lights which can display the diagnosis results and charging status;
alarm 342, which can sound buzz with different frequency to alarm the diagnosis results and charging status.

33. The device as claimed in claim 32, wherein the protect circuit 333 of the secondary control unit 33 is used to detect the battery polarity by use circuit polarity; when the rectifier 331 polarity is the same as battery polarity, the protect circuit 333 would turn on and drive the switch set circuit 332 to output energy to the charge, otherwise, cutoff the output.

34. The device as claimed in claim 32, wherein the display 341 can be composed of LCD.
